(19) United States
(12) Patent Application Publication
(10) Pub. No.: US 2026/0354932 A1
(43) Pub. Date: Nov. 12, 2026

(54) INTERPROXIMAL REDUCTION DENTAL TOOL TIP

(71) Applicant: DentalEZ, Inc., Malvern, PA (US)

(72) Inventors: Brian L. WILK, Dresher, PA (US); Travis FENYVES, Mt. Joy, PA (US); Robert YOUNG, Bethlehem, PA (US); Luther GATES, Gap, PA (US); Michelle GRAY, Oley, PA (US)

(21) Appl. No.: 19/488,670

(22) PCT Filed: May 30, 2024
(86) PCT No.: PCT/US2024/031671

§ 371 Date: Nov. 28, 2025

Related U.S. Application Data
(63) Continuation of application No. 18/206,305, filed on Jun. 6, 2023.

(51) Int. Cl. A61C 3/03; A61C 1/00

(52) U.S. Cl. CPC A61C 3/03; A61C 1/0061

(57) ABSTRACT

A dental tool tip is removably attached to a vibratory dental handpiece. The dental tool tip includes a mounting base configured for removable engagement with the dental handpiece, the mounting base having an open-ended, internal bore extending therethrough and configured for fluid communication with the dental handpiece and a body having a free distal, terminal end and at least a portion of the body having an abrasive coating. A mounting rod proximally extends from the body and is at least partially received within the internal bore. The mounting rod has at least one open-ended passage extending therethrough and in registry and fluid communication with the internal bore, thereby being configured to enable at least one of air or water to advance from the dental handpiece, and flow out onto the body, via the internal bore and the at least one channel.

### BACKGROUND OF THE DISCLOSURE

The disclosure generally relates to a dental tool for interproximal reduction procedures.

Interproximal reduction (IPR) is a dental procedure used to mechanically remove enamel from the interproximal area between two contiguous adjacent teeth, i.e., reducing proximal contacts, in order to assist with orthodontic treatments, such as tooth crowding or reshaping. Traditionally, dental professionals have employed hand filing methods to reduce proximal contacts. Namely, filing instruments such as diamond coated steel strips are inserted between two contiguous adjacent teeth and then manually worked reciprocally back and forth to remove enamel and not just plaque/tartar (i.e., scaling). Manual IPR, however, is a time-consuming procedure that also causes dental professional hand fatigue.

In recent years, power dental tools have been developed for IPR procedures. For example, pneumatically or electrically powered spinning cutting wheels and pneumatically or electrically powered reciprocating cutting implements have been developed for inserting between two contiguous adjacent teeth to reduce proximal contacts. Such spinning or reciprocating tools are often regarded as too aggressive, however, tending to remove too much material at a time. One hazard, which is pronounced when employing more aggressive methods, is tooth “ledging”. Tooth ledging may occur when the gap between two contiguous adjacent teeth is not centered, biasing the tool to cut more into one tooth than the other, creating a ledge on one of the teeth. Another drawback of current cutting implements, such as diamond coated tips or cutting wheels, is that they may become clogged during use, thereby reducing the effective cutting power and adding to patient discomfort.

It would, therefore, be advantageous to develop an IPR dental tool tip mountable with a vibratory dental handpiece, enabling more controlled material removal of proximal contacts with little force input from the dental professional, thereby providing an easier method for reducing the proximal contacts between lateral teeth including reducing hand fatigue and length of time of the procedure.

### BRIEF SUMMARY OF THE DISCLOSURE

Briefly stated, one aspect of the present disclosure is directed to a dental tool tip for removable attachment to a vibratory dental handpiece. The dental tool tip includes a mounting base configured for removable engagement with the dental handpiece, the mounting base having an open-ended, internal bore extending therethrough and configured for fluid communication with the dental handpiece and a body having a free distal, terminal end and at least a portion of the body having an abrasive coating. A mounting rod proximally extends from the body and is at least partially received within the internal bore. The mounting rod has at least one open-ended passage extending therethrough and in registry and fluid communication with the internal bore, thereby being configured to enable at least one of air or water to advance from the dental handpiece, and flow out onto the body, via the internal bore and the at least one channel.

Briefly stated, another aspect of the present disclosure is directed to a method of conducting an IPR procedure including the steps of: (a) positioning the body of the aforementioned dental tool between two contiguous adjacent teeth; (b) vibrating the body via operation of an attached dental handpiece configured to produce vibrations below 20,000 Hz and (c) advancing the strip between the two contiguous adjacent teeth as interproximal enamel tooth material is removed.

### BRIEF DESCRIPTION OF THE SEVERAL VIEWS OF THE DRAWINGS

The following description of the disclosure will be better understood when read in conjunction with the appended drawings. It should be understood, however, that the disclosure is not limited to the precise arrangements and instrumentalities shown. In the drawings:

FIG. 1 is a side view of an IPR dental tool tip, removably attachable to a dental handpiece, in accordance with an embodiment of the present disclosure;

FIG. 2 is a cross-sectional view of the dental tool tip of FIG. 1, taken along sectional line 2-2 of FIG. 1;

FIG. 3 is top, distal and side perspective view of the dental tool tip of FIG. 1, shown schematically connected with a dental handpiece;

FIG. 4 is an expanded, partial top, distal and side perspective view of the dental tool tip of FIG. 1;

FIG. 5 is a top and side perspective view of an alternative configuration of the dental tool tip of FIG. 1;

FIG. 6 is a perspective view of a dental handpiece configured for removable attachment with the dental tool tip of FIG. 1;

FIG. 7 is a cross-sectional view of the dental handpiece of FIG. 6, taken along sectional line 7-7;

FIG. 8 is an enlarged sectional view of the rotor of the dental handpiece of FIG. 6;

FIG. 9 is a top, perspective view of the dental tool tip of FIG. 1 in use within the mouth; and

FIG. 10 is another top, perspective view of the dental tool tip of FIG. 1 in use within the mouth.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the dental tool, and designated parts thereof, in accordance with the present disclosure. In describing the dental tool, the terms proximal and distal are used in relation to the user of the tool, the term proximal being closer to the user (or hand of the user) during use of the dental tool and distal being father from the user during use of the dental tool. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

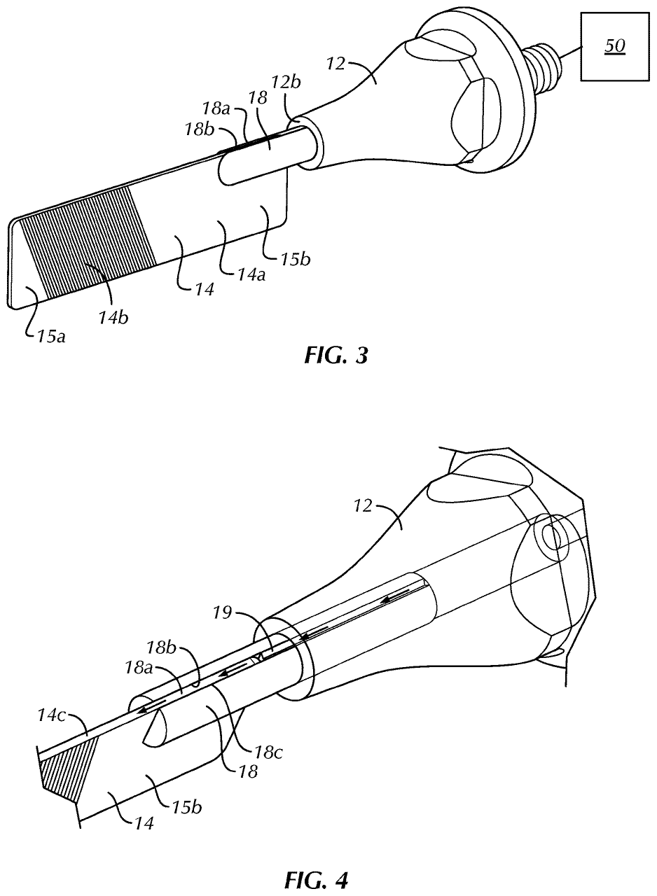

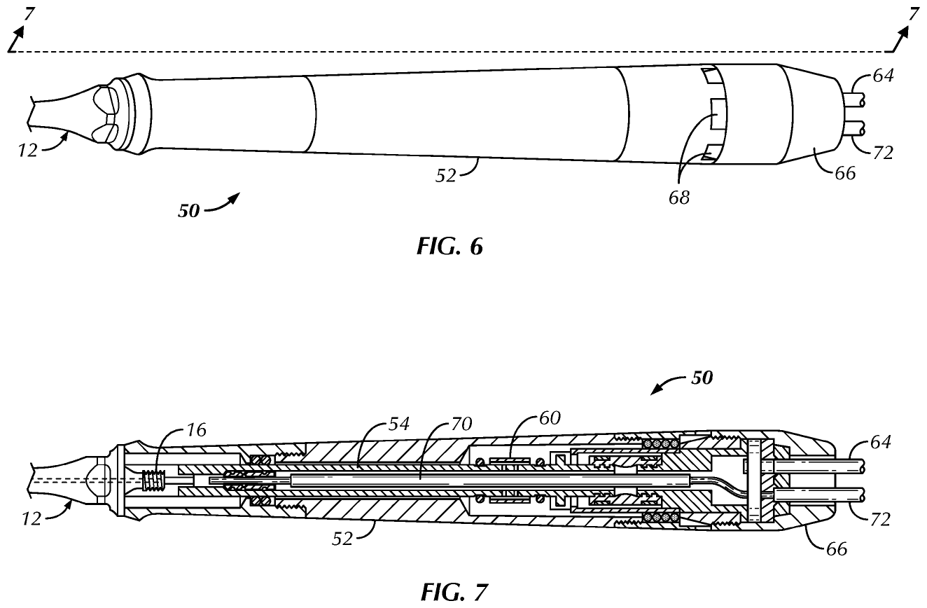

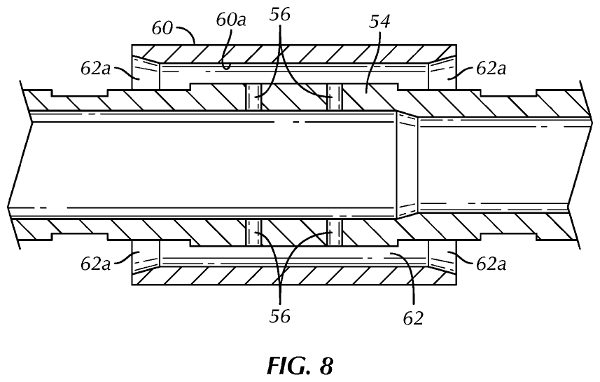

Referring to the drawings in detail, wherein like numerals indicate like elements throughout, there is shown in FIGS. 1-5 and 9-10 an IPR dental tool tip 10, in accordance with an embodiment of the present disclosure, configured for removable attachment to a vibratory dental handpiece 50 (as shown schematically in FIG. 3 as well as in FIGS. 6-8).

The IPR dental tool tip 10 includes a mounting base 12 and an elastically bendable strip 14. In the illustrated embodiment, the mounting base 12 includes a mounting base body 12a and an externally threaded stud 16 proximally extending from the proximal end of the mounting base body 12a. In the illustrated embodiment, the base body 12a may take the form of a shank, but the disclosure is not so limited. The threaded stud 16 is configured for removable, threaded engagement with the dental handpiece 50 (as shown schematically in FIG. 3). The disclosure is not so limited to threaded engagement, however, and the IPR dental tool tip 10 may be removably attachable to the dental handpiece 50 via any of numerous different removable attachment mechanisms currently known or that later become known, e.g., via a snap connection, bayonet connection, a combination thereof, and the like.

In one configuration, the strip 14 may define a generally rectangular body 14a with rounded corners, but the disclosure is not so limited. In one configuration, the strip body 14a may have a thickness of between approximately 0.01 mm and approximately 10 mm, such as, for example, between approximately 0.04 mm and 1.5 mm, as various thicknesses may be necessary for different IPR procedures, depending upon initial and desired interproximal spacing. In one configuration, the strip body 14a may define a generally consistent thickness throughout. Alternatively, the strip body 14a may exhibit a progressively increasing thickness from a thinnest distal end to a thickest proximal end to enable the progressive increase in interproximal spacing during a dental procedure. In one configuration, the strip 14 may define a height H of between approximately one fourth (0.25×) of the size of the smallest patient tooth height (as measured from the cementoenamel junction line to the highest occlusal ridge of the tooth) and approximately five times (5×) the size of the largest patient tooth (as measured from the cementoenamel junction line to the highest occlusal ridge of the tooth). For example, the strip 14 may define a height H of between approximately 0.50 mm and approximately 12.5 mm. In one configuration, the strip 14 may define a length L between a length approximately equal to the width of a patient's largest tooth (as measured from the facial to lingual surfaces) and a length approximately equal to ten times (10×) the width of the largest patient tooth (as measured from the facial to lingual surfaces). For example, the strip 14 may define a length L of between approximately 10 mm and approximately 30 mm.

The strip body 14a may take the form of an elastically deflectable, diamond coated abrasive steel strip, e.g., without limitation, 300 or 400 series stainless steel, or at least include a diamond coated abrasive portion 14b. For example, a distal portion 15a of the strip body 14a may remain uncoated or otherwise be nonabrasive. This uncoated distal portion 15a, which may be thinner than the abrasive portion 14b, may provide a starting area of the strip body 14a to slide in between two contiguous adjacent teeth. In one configuration, the distal portion 15a may define a length between approximately 1 mm and approximately 15, such as, for example, approximately 10 mm. A proximal portion 15b of the strip body 14a may optionally also be uncoated or otherwise be nonabrasive. Different grits of the diamond coated abrasive portion 14b may be employed via different amounts/sizes of medium (diamond) used in the coating process. Different grits may be visually identified via color coding of the strip 14 or other suitable methods, e.g., letter or number coding of the strip 14, a combination thereof or the like, for easy identification of grit level during the dental procedure. The strip body 14a may also be diamond coated on one side or both sides.

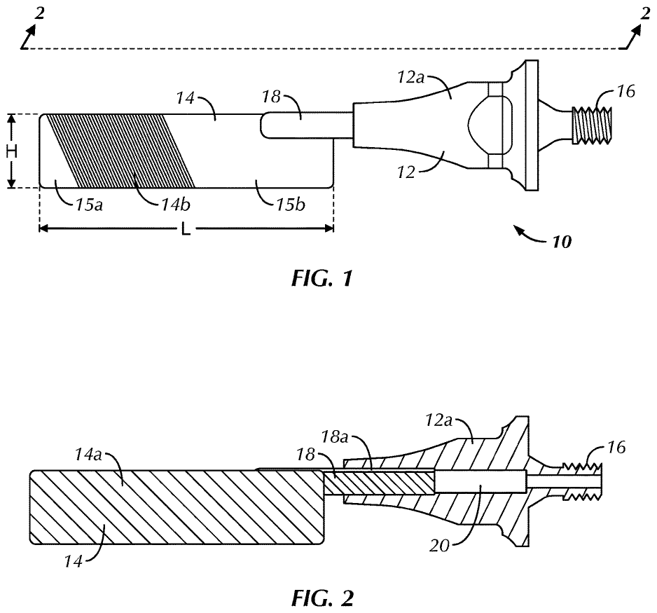

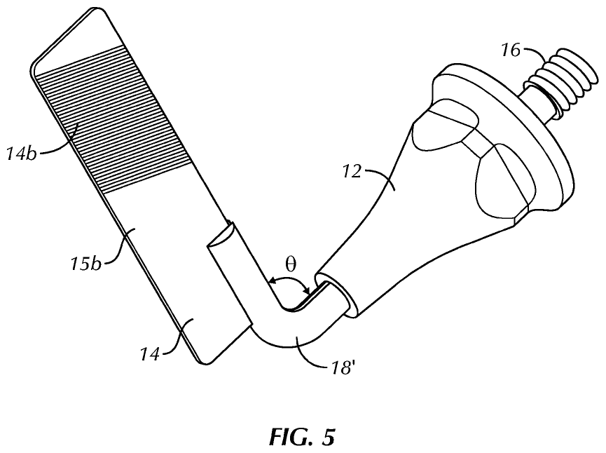

In the illustrated configuration, the strip 14 defines a free distal, terminal end and includes a mounting rod 18 proximally extending from the strip body 14a, e.g., from proximate a proximal end of the strip body 14a. The mounting rod 18 may proximally extend from the strip body 14a in a straight manner, i.e., substantially parallel to the upper edge 14c of the strip body 14a, or at an angle relative to the upper edge 14c. In the illustrated configuration (as shown best in FIGS. 3 and 4), the distal end of the mounting rod 18 includes a proximally extending slit 18b for permanently receiving the strip body 14a, but the disclosure is not so limited. For example, without limitation, the strip body 14a may be monolithically formed with the mounting rod 18, i.e., being formed as a single piece together. As shown best in FIG. 2, the mounting base 12 includes an open-ended internal bore 20 extending entirely through the mounting base body 12a and the threaded stud 16, but the disclosure is not so limited. An open distal end 12b of the mounting base 12 is configured to receive the mounting rod 18 therethrough and into the bore 20. The mounting rod 18 may be secured in a substantially rotationally and axially fixed manner to the bore 20 via a complementary/interference fit within the bore 20, but the disclosure is not so limited. As should be understood, the mounting rod 18 may be secured to the bore 20 in a substantially rotationally and axially fixed manner via any of numerous different individual or combined securement mechanisms, currently known or that later become known.

As shown best in FIGS. 2-4, the mounting rod 18 includes at least one open-ended passage/channel 19 taking the form of a grooved channel along a proximal portion of an uppermost periphery 18c of the mounting rod 18. In the illustrated embodiment, the channel 19 takes the form of a generally v-shaped channel, i.e., defining a v-shape in cross-section, but the disclosure is not so limited. The channel 19 is in registry and in fluid communication with the bore 20, and water may flow along channel 19 via capillary action. In one configuration, and as shown best in FIG. 4, the upper edge 14c of the strip body 14a is depressed relative to the uppermost periphery 18c of the mounting rod 18. Therefore, an open-ended channel 18a is defined between the upper edge 14c of the strip body 14a and the uppermost periphery 18c of the mounting rod 18, along the portion of the slit 18b of the mounting rod 18 occupied by the strip body 14a. The channel 18a is positioned distally in series with the channel 19, thereby enabling air and/or water advancing from the dental handpiece 50 to flow out of the bore 20 via the channels 19 and 18a and onto the strip body 14a, i.e., the cutting/sanding surface, via capillary action to reduce any clogging effect of debris, i.e., clear debris buildup, along the strip body 14a surface during the procedure as well as to lubricate the cutting surface during use, thereby increasing the efficiency of the abrasion (aiding in material removal) and prolonging the life of the strip 14.

In the illustrated embodiment of FIGS. 1-4, the mounting rod 18 takes the form of a substantially straight/linear rod 18. The mounting rod 18 may, however, have other non-linear shapes, such as curved, angled and tapered as required to fit the specific needs of the IPR procedure. FIG. 5 shows one non-limiting example of a curved rod 18′, defining an approximately 90° curve. That is, the curve of the rod 18′ defines an included curve angle 0 of approximately 90°. The curve angle θ of the mounting rod 18′ may range between approximately 90° and approximately 180°, i.e., a straight rod 18.

In one configuration, as shown in FIGS. 6-8, the dental handpiece 50 may take the form of a vibratory dental handpiece, such as, for example, as described in U.S. Patent Nos. RE 29,687, 4,330,282, and 5,062,79, the entire contents of each of which are incorporated by reference herein in their entireties. That is, the dental handpiece 50 may include an elongate handle 52 configured to removably engage/secure the mounting base 12 of the dental tool tip 10 at a distal end of the handle 52 in a manner as previously described. Secured within the elongate handle 12 is a generally coaxial, vibratable, substantially rigid, hollow shaft 54. The mounting base 12 of the dental tool tip 10 is connected, e.g., threadably, to the distal end of hollow shaft 54. As shown best in FIG. 8, the hollow shaft 54 is formed with shaft outlet ports 56 disposed circumferentially around the shaft 54 in the radial sidewall thereof in order to provide fluid communication for fluid media between the inside of tubular shaft 54 to the space externally adjacent the side wall of the shaft 54. Radially disposed, generally concentrically about the shaft 54 is a rotor 60, defining a gap 62 therebetween into which fluid media is directed from shaft outlet ports 56.

The dental handpiece 50 is pneumatically operated. That is, a fluid medium, such as compressed air, is supplied from a source (not shown) through a supply tube 64 which passes through a proximal end cap 66 mounted to the handle 52 and into fluid communication with the hollow shaft 54. The flow of compressed air travels through the hollow shaft 54 to the shaft outlet ports 56. The flow of compressed air exhausts through the shaft outlet ports 56 and contacts the inner wall 60a of the rotor 60 and urges the rotor 60 to rotate about the shaft 54. Each of the shaft outlet ports 56 is angled/slanted relative to the inner wall 60a of the rotor 60 in a non-perpendicular manner, e.g., at angle of less than 90 degrees, thereby each directing a jet of air at a glancing angle with respect to the inner wall 60a of the rotor 60, and providing a thrust on the rotor 60 imparting a rotational movement to the rotor 60. The air travels into the handle 52 through open end sections 62a of the gap 62 and subsequently exhausts into the atmosphere through handle outlet ports 68 of the handle 52. A hollow elongate tube 70 is disposed within the hollow shaft 54 and extends from a proximal section of the handle 52 to a distal section of the handle 52. Proximally, the elongate tube 70 is in fluid communication with a water supply tube 72, and distally the elongate tube 70 fluidly communicates with the bore 20 of the dental tool tip 10. The elongate tube 70 serves to carry water supplied via the water supply tube 72 from a source (not shown) to the dental tool tip 10 to assist with debris removal and lubricate the cutting surface of the tool tip 10 (as previously described).

The dental handpiece 50 is operated by connecting the handpiece 50 to the sources of air and water. During operation, compressed air enters the hollow shaft 54 and ultimately causes the rotor 60 to rotate (as previously described). As the dental handpiece 50 operates, the rotor 60, in addition to rotating, oscillates in both the axial and radial directions. As the rotor 60 rotates and oscillates, the rotor 60 repeatedly impacts against the hollow shaft 54, thereby causing the hollow shaft 54 to vibrate. The compressed air flow rate is adjusted to desired values configured to produce the desired vibrations rate, generally below 20,000 Hz, e.g., generally sonic vibration levels. For example, the air flow rate may be adjusted to approximately 1.5 standard cubic feet of air per minute (scfm) at a pressure of about 40 pounds per square inch gauge (psig). Under such conditions, the rotor 60 will cause the shaft 54 to vibrate between approximately 5,000 Hz and approximately 6,500 Hz, such as, for example, between approximately 5,500 Hz and approximately 6,400 Hz, with a vibration amplitude of approximately 0.17 G and approximately 1.04 G.

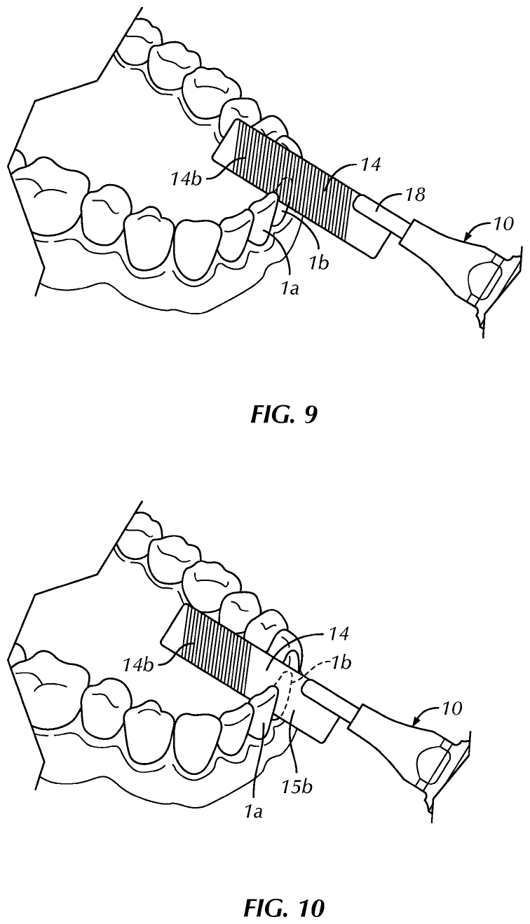

A plurality of IPR dental tool tips 10 may be provided together in the form of a kit, such that a dental professional may select the appropriately sized tip(s) 10 to perform the IPR procedure. The dental professional may also swap tips 10 throughout the procedure via the removable connection between each tip 10 and the handpiece 50. Alternatively, a single dental tool tip 10 may be sufficient for the entire procedure. In use, as shown in FIGS. 9, 10, a strip 14 of the desired dimensions, i.e., one or more of thickness, length and height, according to the initial spacing between two contiguous adjacent teeth, is positioned between the desired adjacent teeth 1a, 1b at the terminal free end of the teeth and the handpiece 50 is operated (e.g., via the pneumatically powered vibratory shaft 54) in the apical direction. As should be understood, two exemplary contiguous adjacent teeth are labeled as 1a, 1b in FIGS. 9, 10, but the tool tip 10 may be employed for an IPR procedure between any two contiguous adjacent teeth along the mandible or along the maxilla within the mouth. As interproximal material, e.g., enamel, between the contiguous adjacent teeth 1a, 1b is removed, the strip 14 is advanced, i.e., in the apical direction, toward the gum line.

When employing a strip 14 that is substantially entirely abrasive (FIG. 9), the abrasive strip body 14a vibrates/oscillates, substantially without reciprocating the body in the buccal and lingual directions, and, in turn, removes interproximal material. Optionally, when employing a strip 14 having a nonabrasive portion (either distally 15a and/or proximally 15b) (FIG. 10), the nonabrasive portion 15a, 15b may initially be positioned between the desired contiguous adjacent teeth 1a, 1b, e.g., proximate a tip of the crowns thereof, and the handpiece 50 is operated. Once more space is created between the teeth 1a, 1b, the strip 14 may be translated in the buccal or lingual directions to position an abrasive portion 14b between the contiguous adjacent teeth 1a, 1b to remove more material. Additionally or alternatively, should more material need to be removed between teeth 1a, 1b, a thicker strip 14 may subsequently be employed and the process repeated. Air and/or water may be advanced from the handpiece 50 (as previously described) to flow through the bore 20 via the channels 19 and 18a and flow onto the strip body 14a, e.g., enveloping the face of the abrasive surface, to reduce clogging effect of debris along the strip body 14a surface and to lubricate the cutting surface to aid in material removal. Advantageously, the substantially elastic bendability of the strip 14 enables bending of the strip 14 around teeth, substantially maintaining the natural contour of the teeth. One factor benefitting the bendability of the strip body 14a is the geometry thereof. For example, the strip body 14a may define a length to thickness ratio of between approximately 50:1 and approximately 150:1, such as, for example, approximately 100:1. The strip body 14a may additionally or alternatively define a length to height ratio of between approximately 4:1 and approximately 10:1, such as, for example, approximately 7:1. As should be understood, the greater the ratio, the more easily bendable the strip body 14a. The combination of one or more of the vibration from the dental handpiece 50, the bendability of the strip 14 and the air/water cleaning/lubrication improves and simplifies the IPR procedure.

IPR dental tool tips 10 may also be used to reduce proximal contacts of adjacent Zirconia Crowns during such procedures. Advantageously, the vibrational/oscillating motion of the tip 10 will allow for an easier cutting/sanding operation as performed by the dental professional, reducing hand fatigue and decreasing the amount of time the reduction takes as well. Moreover, IPR procedures performed with the IPR dental tool tips 10 will be safer for patients as there will be no rotating cutting implements or reciprocating sawing elements for patient soft tissue to come in contact with. The introduction of air and water via the passage/channel 18a will also help to keep the diamond coated surface free of debris and not become clogged resulting in more efficient cutting/sanding.

It will, therefore, be appreciated by those skilled in the art that various modifications and alterations could be made to the disclosure above without departing from the broad inventive concepts thereof. Some of these have been discussed above and others will be apparent to those skilled in the art. It is understood, therefore, that this invention is not limited to the particular embodiments disclosed, but it is intended to cover modifications within the spirit and scope of the present disclosure, as set forth in the appended claims.

We claim:

1. A dental tool tip for removable attachment to a vibratory dental handpiece, the dental tool tip comprising:
a mounting base configured for removable engagement with the vibratory dental handpiece, the mounting base having an open-ended, internal bore extending therethrough and configured for fluid communication with the vibratory dental handpiece;
a body having a free distal, terminal end and at least a portion of the body having an abrasive coating; and
a mounting rod proximally extending from the body and at least partially received within the internal bore, the mounting rod having at least one open-ended passage extending therethrough and in registry and fluid communication with the internal bore, thereby being configured to enable at least one of air or water to advance from the vibratory dental handpiece, and flow out onto the body, via the internal bore and the at least one channel.

2. The dental tool tip of claim 1, wherein the mounting base further includes an externally threaded stud proximally extending from the mounting base, the stud being configured to removably, threadedly engage the vibratory dental handpiece.

3. The dental tool tip of claim 2, wherein the internal bore extends through the mounting base.

4. The dental tool tip of claim 1, wherein the body is generally flat and rectangularly shaped.

5. The dental tool tip of claim 1, wherein the mounting rod includes a slit receiving a portion of the body therein.

6. The dental tool tip of claim 5, wherein an upper edge of the body is depressed relative to an uppermost periphery of the mounting rod, thereby forming an open-ended channel defined between the upper edge of the body and the uppermost periphery of the mounting rod along a portion of the slit occupied by the body, the open-ended channel being configured to permit water to flow therethrough and onto the body.

7. The dental tool tip of claim 6, wherein the mounting rod includes at least one open-ended grooved channel formed along the uppermost periphery of the mounting rod, the grooved channel being in fluid communication with the internal bore and in fluid communication with the open-ended channel 8. The dental tool tip of claim 7, wherein the grooved channel is generally v-shaped in cross-section.

9. The dental tool tip of claim 1, wherein the body defines a thickness between approximately 0.01 mm and approximately 10 mm.

10. The dental tool tip of claim 1, wherein the body defines a progressively increasing thickness from a thinnest distal end to a thickest proximal end.

11. The dental tool tip of claim 1, wherein the body defines a height between approximately 0.5 mm and approximately 12.5 mm.

12. The dental tool tip of claim 1, wherein the body defines a length between approximately 10 mm and approximately 30 mm.

13. The dental tool tip of claim 1, wherein the body defines a length to thickness ratio of between approximately 50:1 and approximately 150:1.

14. The dental tool tip of claim 1, wherein the body defines a length to height ratio of between approximately 4:1 and approximately 10:1.

15. The dental tool tip of claim 1, wherein the mounting rod is non-linear.

16. The dental tool tip of claim 1, wherein the abrasive coating comprises a diamond coating.

17. The dental tool tip of claim 1, in combination with the vibratory dental handpiece.

18. The dental tool tip of claim 1, in combination with the vibratory dental handpiece, wherein the vibratory dental handpiece is configured to produce vibrations below 20,000 Hz.

19. A method of conducting an IPR procedure comprising the steps of:
positioning the body of the dental tool of claim 18 between two contiguous adjacent teeth;
vibrating the body via operation of the attached vibratory dental handpiece; and
advancing the strip between the two contiguous adjacent teeth as interproximal enamel tooth material is removed.

20. The method of claim 19, wherein the positioning step comprises:
positioning the portion of the body having the abrasive coating between the two contiguous adjacent teeth near a tip of a crown of the teeth and moving the vibratory dental handpiece toward the gum line without reciprocating the body in buccal and lingual directions.

21. The method of claim 19, wherein the positioning step comprises:
positioning a portion of the body without the abrasive coating between the two contiguous adjacent teeth, and further comprising the step of translating the strip in a buccal or lingual direction to position the portion of the body having the abrasive coating between the two contiguous adjacent teeth.

22. The method of claim 19, further comprising the step of:
advancing at least one of air or water from the vibratory dental handpiece, through the internal bore, the grooved channel and the open-ended channel and along the upper edge of the body, wherein the air or water envelopes a face of the abrasive coatcing.

23. The method of claim 19, further comprising the step of bending the body toward one of the two contiguous adjacent teeth.

24. The method of claim 19, further comprising the step of selecting an appropriately sized dental tool tip from a kit comprising a plurality of differently sized dental tool tips of claim 18.

25. The method of claim 19, wherein the vibrating step comprises:
vibrating the strip at between approximately 5,500 Hz and approximately 6,400 Hz, with a vibration amplitude of between approximately 0.17 G and approximately 1.04 G.
